(19) United States
(12) Patent Application Publication
(10) Pub. No.: US 2009/0260714 A1
(43) Pub. Date: Oct. 22, 2009

(54) BEVERAGE BOTTLE OR CONTAINER FILLING MACHINE FOR FILLING BOTTLES OR CONTAINERS WITH STILL WATER OR OTHER NON-CARBONATED BEVERAGES

(76) Inventors: Dieter-Rudolf KRULITSCH, Bad Kreuznach (DE); Bernd BRUCH, Weinsheim (DE)

Correspondence Address: NILS H. LJUNGMAN & ASSOCIATES, P. O. BOX 130, GREENSBURG, PA, 15601-0130, US

(21) Appl. No.: 12/429,809

(22) Filed: Apr. 24, 2009

Related U.S. Application Data
(63) Continuation-in-part of application No. PCT/EP2007/009214, filed on Oct. 24, 2007.

(30) Foreign Application Priority Data
Oct. 27, 2006 (DE) 10 2006 050 780.0

(51) Int. Cl. B67C 3/00

(52) U.S. Cl. 141/311 R

(57) ABSTRACT

A beverage bottle or container filling machine for filling bottles or containers with still water or other non-carbonated beverages. The abstract of the disclosure is submitted herewith as required by 37 C.F.R. §1.72(b). As stated in 37 C.F.R. §1.72(b): A brief abstract of the technical disclosure in the specification must commence on a separate sheet, preferably following the claims, under the heading “Abstract of the Disclosure.” The purpose of the abstract is to enable the Patent and Trademark Office and the public generally to determine quickly from a cursory inspection the nature and gist of the technical disclosure. The abstract shall not be used for interpreting the scope of the claims. Therefore, any statements made relating to the abstract are not intended to limit the claims in any manner and should not be interpreted as limiting the claims in any manner.

### CONTINUING APPLICATION DATA

This application is a Continuation-In-Part application of International Patent Application No. PCT/EP2007/009214, filed on Oct. 24, 2007, which claims priority from Federal Republic of Germany Patent Application No. 10 2006 050 780.0, filed on Oct. 27, 2006. International Patent Application No. PCT/EP2007/009214 was pending as of the filing date of this application. The United States was an elected state in International Patent Application No. PCT/EP2007/009214.

### BACKGROUND

1. Technical Field

The present application relates to a beverage bottle or container filling machine for filling bottles or containers with still water or other non-carbonated beverages. The present application further relates to an apparatus for the filling of bottles in one possible embodiment with still water, with a product delivery via a filling valve which is placed over the head of the bottle and a degassing line for the removal of the air displaced from the interior of the bottle during the filling process, whereby the valve body is realized so that it can be raised and lowered by means of a lifting wheel which is guided over a slide path surface.

2. Background Information

Background information is for informational purposes only and does not necessarily admit that subsequently mentioned information and publications are prior art.

Devices for filling bottles or similar containers are known in a wide variety of configurations, for example, which have filling valves for, among other things, the removal of the gas volume which is present in the bottle when the liquid to be bottled is introduced, which filling valves can be activated, for example, by lowering them onto the bottle. These constructions, some of which are open in whole or in part, are in many cases unable to meet the requirements that have been set to essentially guarantee or promote the sterility of the bottling process.

Some devices describe comparable filling heads which are lowered onto the bottle by means of a telescoping system of tubes to essentially ensure or promote the removal of the gas in the bottle on one hand and the filling of the bottle on the other hand. Here, too, there are limits on the sterility of the filling process, for example because the telescoping elements, for example a tube and a movable collar that is located on this tube, are realized so that a seal is moved in a permanent or substantially permanent back-and-forth movement over the external surface of the tube, and thus the external surfaces areas are exposed to the open, non-sterile atmosphere (air) at one point, and at another point are in direct contact with the liquid being bottled, as a result of which germs that are hazardous or harmful to health can get into the liquid being bottled.

### OBJECT OR OBJECTS

An object of the present application is to essentially guarantee or promote a bottling process which is as sterile as possible, i.e. to minimize the entry of germs via the filling head of the bottles.

### SUMMARY

The present application teaches that this object is accomplished by an apparatus for the filling of bottles, in one possible embodiment with still water, with a product delivery via a filling valve which is placed over the head of the bottle and a degassing line for the removal of the air displaced from the interior of the bottle during the filling process. The valve body is realized so that it can be raised and lowered by means of a lifting wheel which is guided over a slide path surface. The valve body which is provided with a passage hole for the displaced air is provided on its free end with a guide cylinder which extends the passage hole and is connected immovably with it. The guide cylinder is surrounded at some distance by a movable ring body. A fluid tight elastic collar is provided between the free end of the valve body and the edge of the movable ring body facing this end.

By providing a fluid-tight elastic collar which tracks the up and down movements of the valve body, the present application essentially guarantees or promotes that the space behind the immediate vicinity or general vicinity of the valve closing body is sealed off from the environment. The collar can easily fit over different sizes of bottles, in one possible embodiment in terms of their axial dimension. In another possible embodiment of the present application, the interior of the valve chamber becomes significantly smaller.

Possible embodiments of the present application are described according to the present application.

In at least one possible embodiment of the present application, the free end of the valve body has a central blind hole with a larger diameter than the guide cylinder which is fastened there, and the product delivery line empties into this blind hole, whereby this product feed line is simultaneously or substantially the axle of the lifting wheel which raises and lowers the movable part of the cylinder or filling valve head by means of a slide path surface.

These configurations make possible a simple, effective, and easy-to-maintain construction of the filling head.

Because a valve body is provided with a conical bead that is directed outward and is surrounded by a ring-shaped body, in the interior of which there is both a sealing ring which comes into contact against the annular bead and an additional sealing ring which comes into contact with the bottle neck, and this ring body is held by the collar so that it can move freely, the result is an additional realization of the apparatus according to the present application.

The above-discussed embodiments of the present invention will be described further herein below. When the word “invention” or “embodiment of the invention” is used in this specification, the word “invention” or “embodiment of the invention” includes “inventions” or “embodiments of the invention”, that is the plural of “invention” or “embodiment of the invention”. By stating “invention” or “embodiment of the invention”, the Applicant does not in any way admit that the present application does not include more than one patentably and non-obviously distinct invention, and maintains that this application may include more than one patentably and non-obviously distinct invention. The Applicant hereby asserts that the disclosure of this application may include more than one invention, and, in the event that there is more than one invention, that these inventions may be patentable and non-obvious one with respect to the other.

### BRIEF DESCRIPTION OF THE DRAWINGS

Additional features and details of the present application are discussed in the following description and are illustrated in the accompanying drawings, in which:

FIG. 1 is an expanded overview of a filling station with the apparatus according to the present application;

FIG. 2 an enlarged detail of the filling valve in the circle marked II in FIG. 1;

FIGS. 3 to 11 illustrate the filling station in different stages of operation; and

FIG. 12 shows schematically the main components of one possible embodiment example of a system for filling containers, for example, a beverage bottling plant for filling bottles with at least one liquid beverage, in accordance with at least one possible embodiment, in which system or plant could possibly be utilized at least one aspect, or several aspects, of the embodiments disclosed herein.

### DESCRIPTION OF EMBODIMENT OR EMBODIMENTS

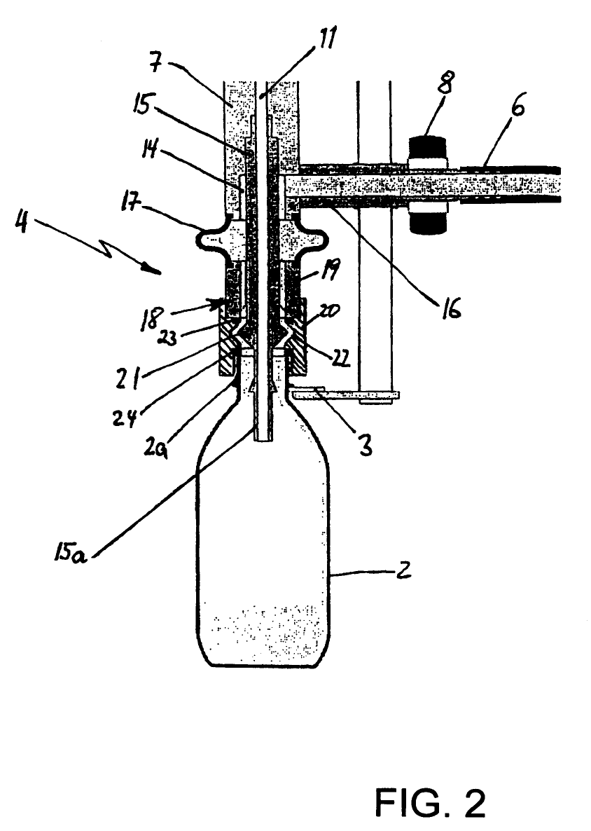

The apparatus, which is designated 1 in general and is shown in section and schematically in the figures, is used for the filling of bottles 2 which are delivered to the bottling device 1 via a suspended transport, for example, whereby the bottle necks 2a are pushed into a holder 3 by the corresponding transport collar. The bottles 2 are filled from a product tank 5 via a valve which is designated 4 in general and is shown in an enlarged view in FIG. 2. The delivery line for the liquid being bottled is designated 6 and can be formed at least partly, for example, by a transparent silicone or rubber hose.

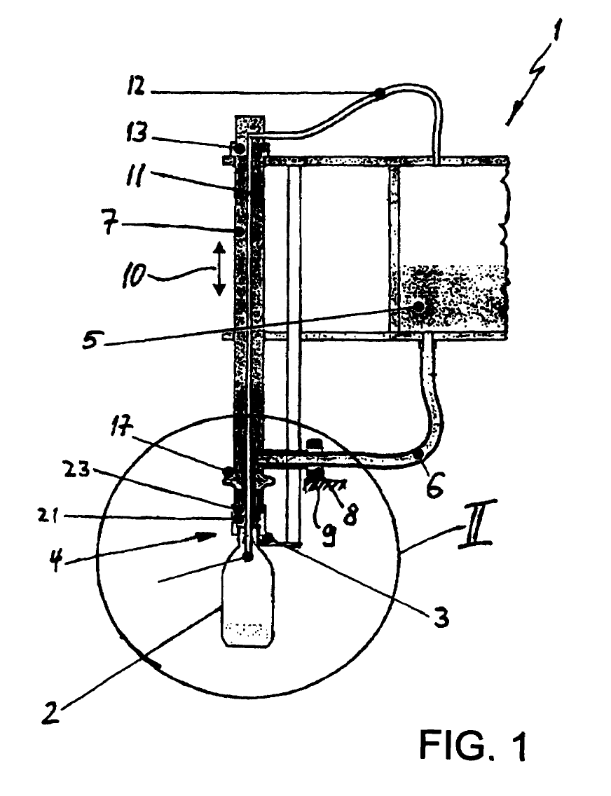

The valve body designated 7 can be raised by means of a lifting wheel 8 which runs over a slide path surface 9 shown in FIG. 1, whereby the valve body 7 is lowered essentially by the force of gravity. This up and down motion is indicated in FIG. 1 by a double arrow 10.

For the return of the gas from the bottle 2 during the filling process, the valve body has a passage hole 11 which is in communication with the product tank 5 by means of a gas return line 12.

The valve body 7, on its upper end in the direction of the force of gravity, has a stop collar 13 to limit its downward movement.

As illustrated in FIG. 2, the valve body 7 is provided on its lower end in the direction of the force of gravity with a blind hole 14 in which a guide cylinder which represents an extension of the passage hole 11 is fastened, whereby the guide cylinder or valve projection 15 has an outside diameter which is less than the inside diameter of the passage hole 11.

The product delivery line, which in this case is formed by the axle 16 of the lifting wheel 8 which is fastened to the valve body, empties into the base area of the blind hole 14.

On the lower, free end of the valve body, an elastic collar or a diaphragm 17 is fastened, which in turn supports a ring body which is designated 18 in general on its lower edge. This ring body is formed by two rings 19 and 20 which are immovably connected to each other.

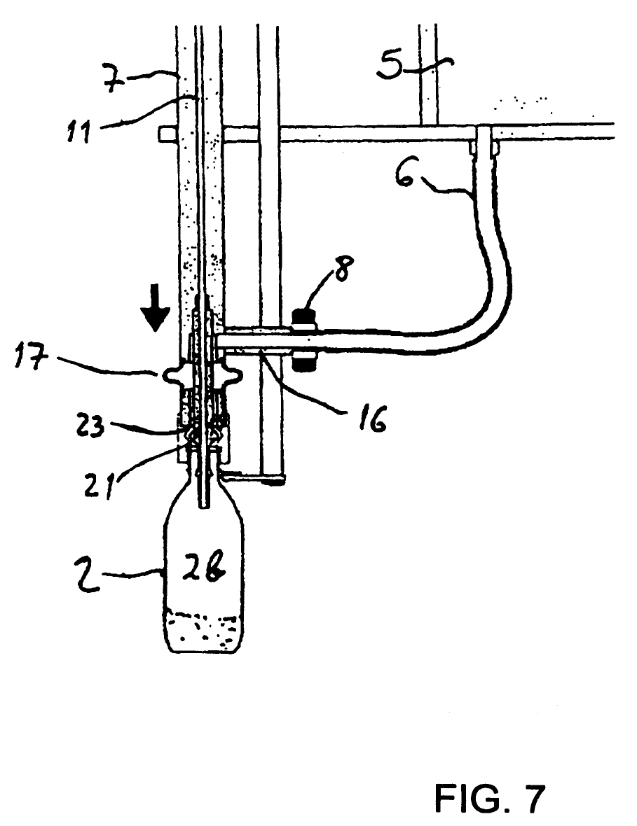

As shown in FIG. 2, the guide cylinder 15 is provided with a conical bead 21 which projects outward, whereby the ring 20 which is associated with this conical bead 21 is provided with a correspondingly shaped conical groove 22, the inside diameter of which is greater than the outside diameter of the conical bead 21 to form an annular gap for the passage of the product when the valve is opened (as in FIG. 7, for example). For this reason, the ring 19 has a larger inside diameter than the outside diameter of the guide cylinder 15.

The inside dimensions of the ring 20 relative to the dimensions of the ring 19 are set so that a shoulder which holds a sealing ring 23 is realized in the connecting area, whereby farther down in the direction of gravity is an additional shoulder in the inside of the ring 20 which supports an additional sealing ring 24 which comes into contact with the upper edge of the bottle neck 2a.

FIG. 2 also shows that the guide cylinder 15 is provided on its lower free end with a tubular gas return line 15a which extends beyond the contour of the ring body 18.

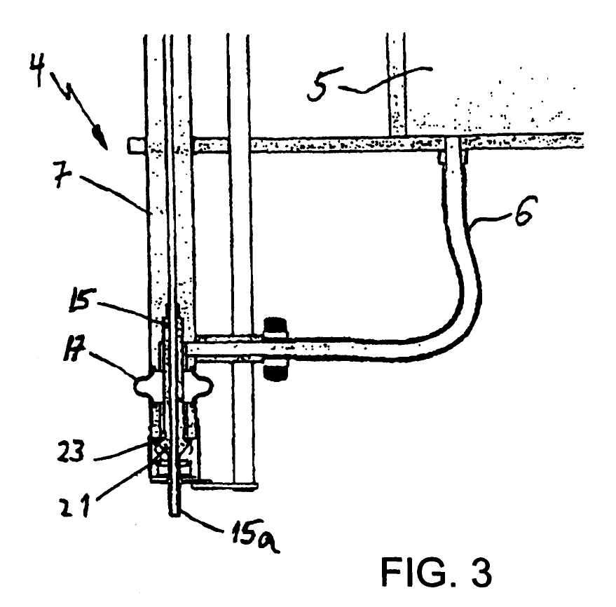

The operation of the apparatus according to the present application is described in greater detail below with reference to FIGS. 3 to 11.

FIG. 3 shows the position in which the valve is closed by a valve body 7 which is lowered by the force of gravity, so that the inner sealing ring 23 is in contact with the inner conical surface of the conical bead 21 of the guide cylinder 15.

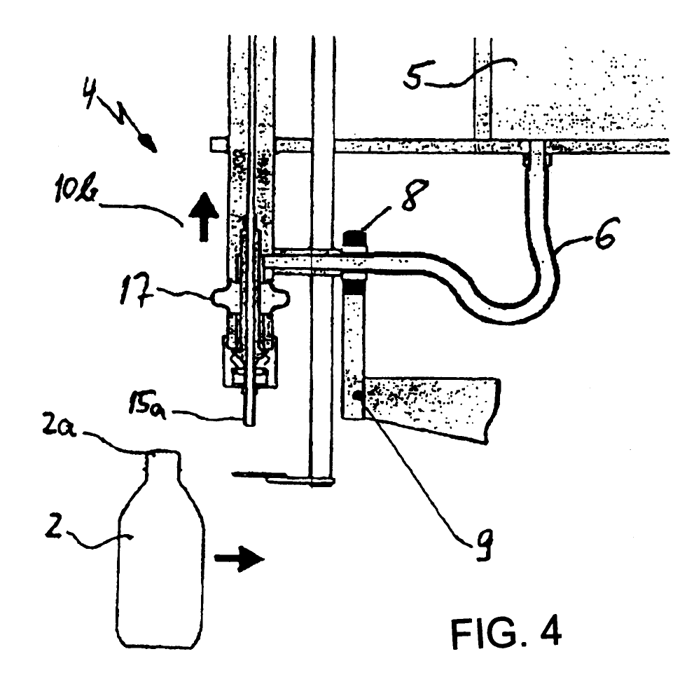

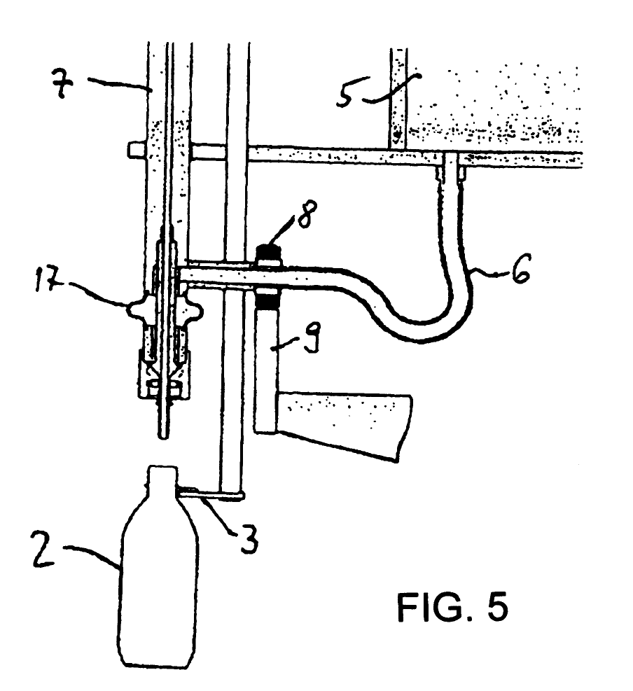

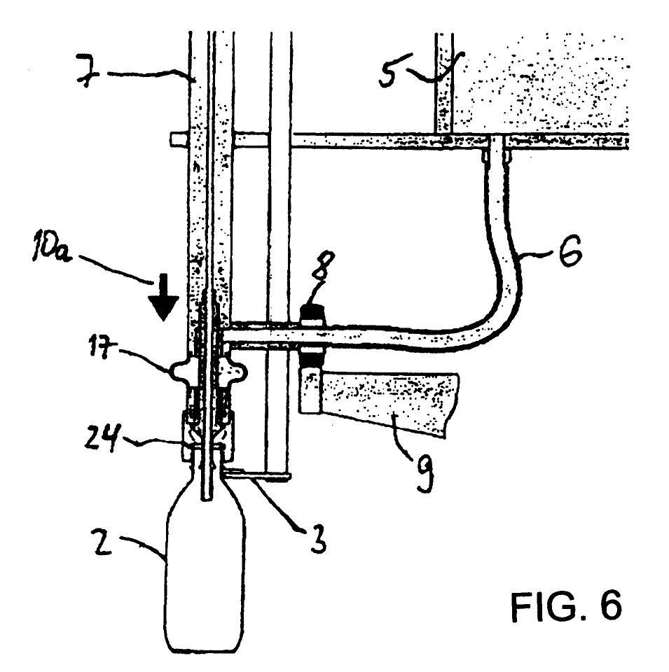

When an empty bottle 2 is transported as illustrated in FIG. 4, the valve 4, by means of the lifting wheel 8 which is raised over a slide path surface 9, is also in the raised position which is indicated by an arrow 10b. When the bottle 2 is positioned with its bottle neck 2a in the bottle carrier 3 (FIG. 5), the valve body 7 can be lowered as illustrated by the arrow 10a in FIG. 6. This movement occurs as a result of the appropriate shaping of the slide path surfaces 9 and is assisted by the force of gravity and the resulting contact of the lifting wheel 8 with the slide path surface 9. The sealing ring 24 is thereby in sealed contact against the upper edge of the bottle neck 2a of the bottle 2.

For example, if the lifting wheel 8 leaves the slide path surface 9 on which it rests, as shown in FIG. 7, the valve body 7, as a result of the force of gravity, moves downward by an additional amount, whereby the collar 17 which connects the ring body 18 with the valve body 7 is compressed by raising the ring body 18, and simultaneously or substantially simultaneously the sealing ring 23 is detached from the conical bead 21 and thereby opens a flow duct for the product flowing out of the product tank 5 through the hose 6 and the axis 16. At the same time the gas is displaced by the incoming product from the interior 2b of the bottle 2 illustrated in FIG. 7 via the central degassing hole 11.

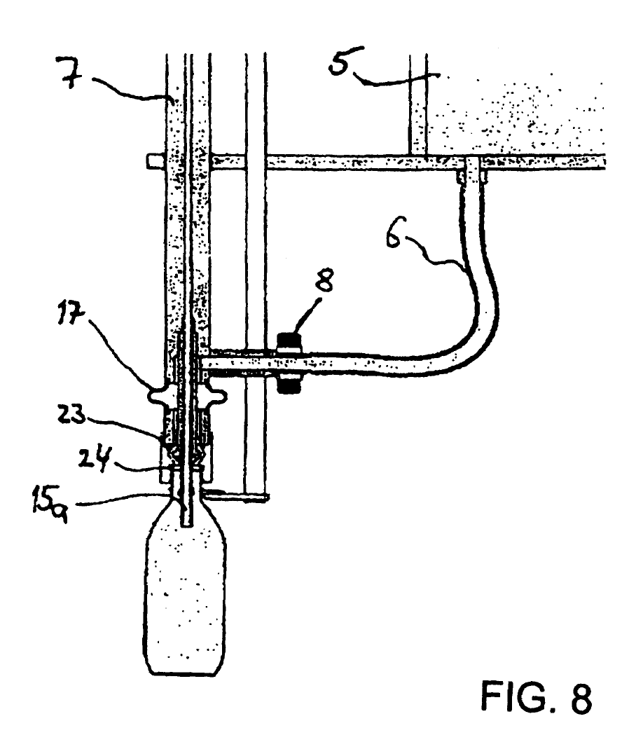

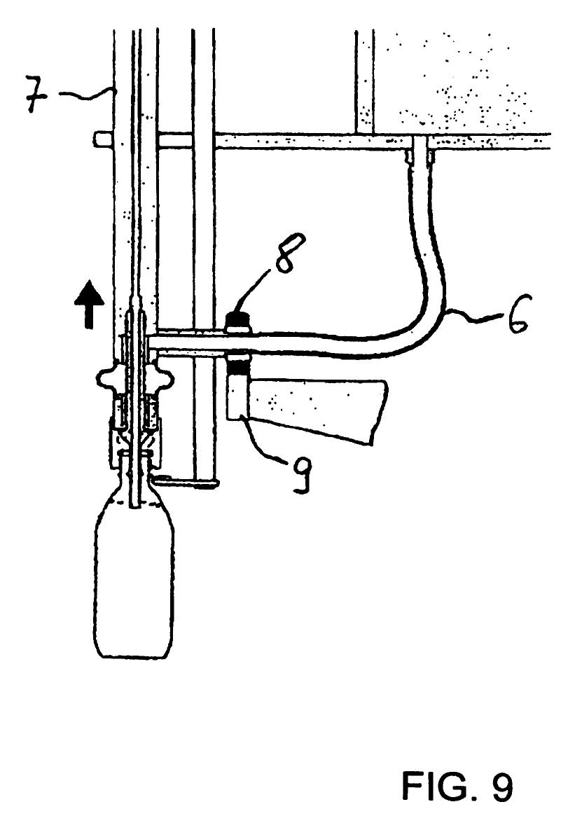

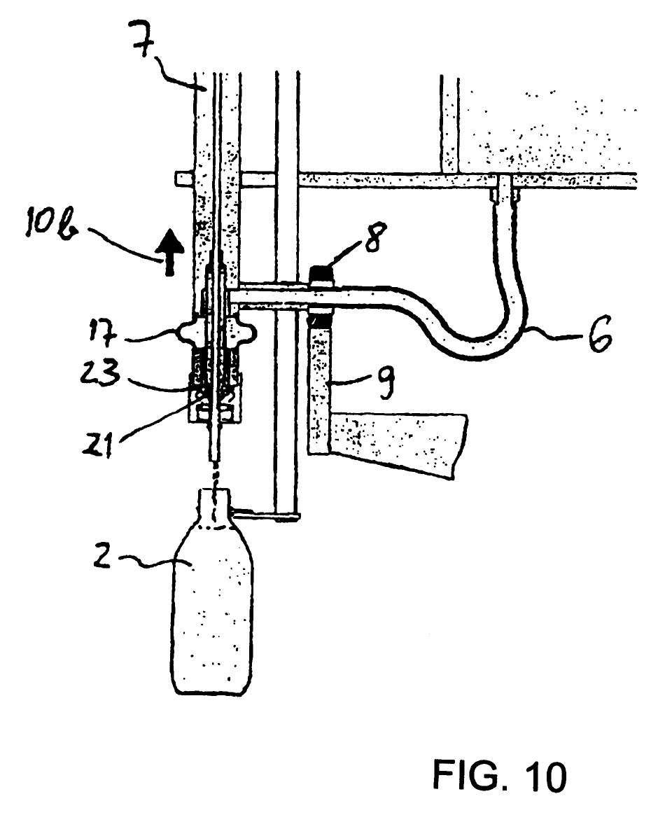

The filling process is ended when the product level reaches the end of the degassing line as illustrated in FIG. 8. Then, via the lifting wheel 8 and the slide path surface 9 provided for it, the valve body 7 is raised again (arrow 10b), so that as a result of the force of gravity, the sealing ring 23 can once again be in contact with the inner cone of the conical bead 21. This closed position of the valve is illustrated in FIG. 9. As the valve body 7 is raised farther by means of the lifting wheel 8 and the slide path surface 9, the end 15a of the degassing line 15 which projects beyond the valve is lifted out of the bottle. The product remaining in the degassing line flows into the bottle, as illustrated in FIG. 10.

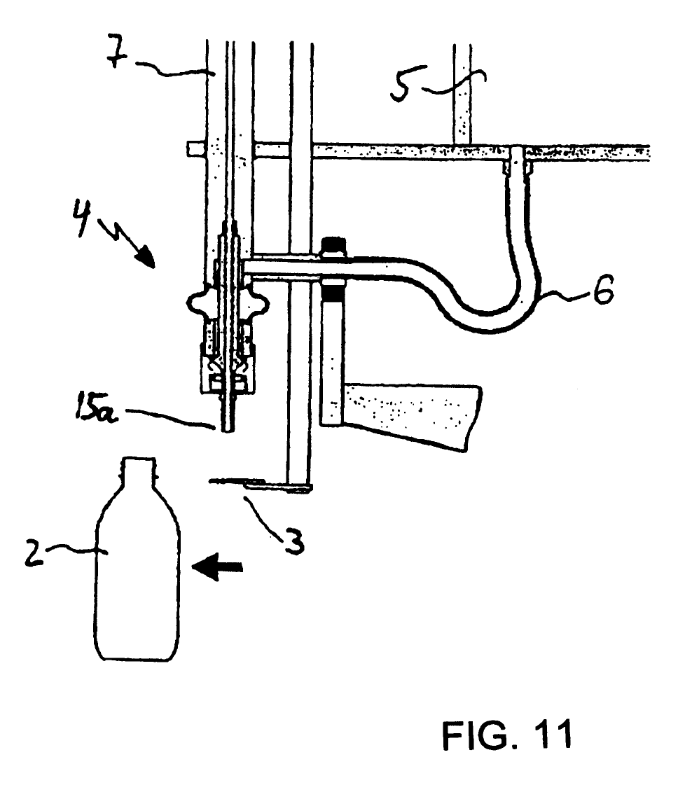

Finally, FIG. 11 shows the removal of the bottle 2 from the filling device 1 after the filling process.

In at least one possible embodiment of the present application, the cam system utilizing the lifting wheel 8 and slide path surface 9 can be replaced with a hydraulic, mechanical, or otherwise powered lifting and lowering arrangement. A hydraulic or mechanical lifting and lowering arrangement can be utilized for the controlled movement of the valve body 7 in both the upward and downward directions. The downward movement of the valve body 7 may be assisted by gravity and controlled by the hydraulic, mechanical, or otherwise powered lifting and lowering arrangement. The upward movement can be controlled by the hydraulic, mechanical, or otherwise powered lifting and lowering arrangement.

In at least one possible embodiment of the present application, the filling valve 4 and the valve body 7 may be stationary during the filling process while the holder 3 can be moved by a cam system, hydraulic, mechanical, or otherwise powered lifting and lowering arrangement. Alternatively, in at least one possible embodiment according to the present application, both the holder 3 and the filling valve 4 and/or the valve body 7 may be moved relative to one another during the filling process. For example, to begin the filling process, the holder 3, and therefore the bottle or container 2, may be moved in an upward direction while substantially simultaneously the valve body 7 can be moved in a downward direction, assisted by gravity, and into the bottle 2.

The valve body 7 may be configured to be moved in a vertical or substantially vertical direction a sufficient length of distance to promote optimal opening and closing of the filling valve 4. For example, when the conical bead 21 rests against the sealing ring 23 and the filling valve 4 is in a closed position, the conical bead 21 may be lowered a sufficient distance away from the sealing ring 23 and into the conical groove 22. However, if the conical bead 21 is lowered too far into the conical groove 22, the conical bead 21 will then rest against the bottom surface of the conical groove 22 which abuts the sealing ring 24, effectively closing the filling valve 4. Therefore, the stop collar 13 disposed on the apparatus 1 could be positioned to allow the valve body 7 to be lowered a sufficient distance to open the filling valve 4 to promote optimal filling of the bottle 2 without closing the filling valve 4.

In at least one possible embodiment of the present application, the apparatus 1 of the present application may be used for filling bottles or similar containers 2 with still water. It is also within the scope of the present application to utilize the apparatus 1 for the filling of bottles or similar containers 2 with other non-carbonated beverages or liquids, including but not limited to distilled water, spring water, mineral water, fruit juices, wines, sports drinks, milk, among others. Some liquids or beverages should not come in contact with air or atmospheric air during the filling process. In such embodiments, the bottles or similar containers 2 may be flooded with gas, such as nitrogen gas, before being fed into the holders 3. An identical, similar, or substantially similar gas may be housed in the product tank 5. When the beverage or liquid is then dispensed into a bottle or container 2, the liquid displaces the gas in the bottle or container 2, which flows through the tubular extension 15a, degassing line 12, and/or passage hole 11 and into the product tank 5.

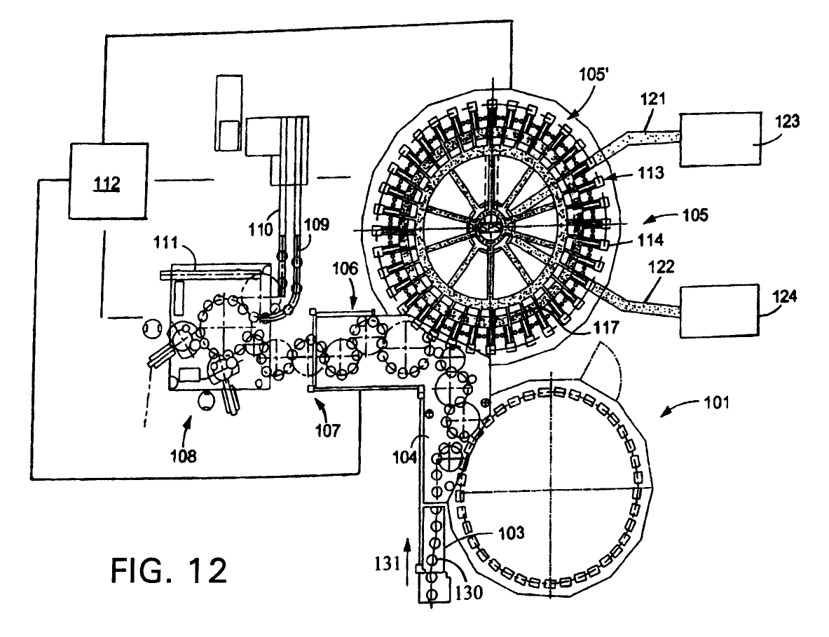

FIG. 12 shows schematically the main components of one possible embodiment example of a system for filling containers, for example, a beverage bottling plant for filling bottles 130 with at least one liquid beverage, in accordance with at least one possible embodiment, in which system or plant could possibly be utilized at least one aspect, or several aspects, of the embodiments disclosed herein.

FIG. 12 shows a rinsing arrangement or rinsing station 101, to which the containers, namely bottles 130, are fed in the direction of travel as indicated by the arrow 131, by a first conveyer arrangement 103, which can be a linear conveyor or a combination of a linear conveyor and a starwheel. Downstream of the rinsing arrangement or rinsing station 101, in the direction of travel as indicated by the arrow 131, the rinsed bottles 130 are transported to a beverage filling machine 105 by a second conveyer arrangement 104 that is formed, for example, by one or more starwheels that introduce bottles 130 into the beverage filling machine 105.

The beverage filling machine 105 shown is of a revolving or rotary design, with a rotor 105′, which revolves around a central, vertical machine axis. The rotor 105′ is designed to receive and hold the bottles 130 for filling at a plurality of filling positions 113 located about the periphery of the rotor 105′. At each of the filling positions 103 is located a filling arrangement 114 having at least one filling device, element, apparatus, or valve. The filling arrangements 114 are designed to introduce a predetermined volume or amount of liquid beverage into the interior of the bottles 130 to a predetermined or desired level.

The filling arrangements 114 receive the liquid beverage material from a toroidal or annular vessel 117, in which a supply of liquid beverage material is stored under pressure by a gas. The toroidal vessel 117 is a component, for example, of the revolving rotor 105′. The toroidal vessel 117 can be connected by means of a rotary coupling or a coupling that permits rotation. The toroidal vessel 117 is also connected to at least one external reservoir or supply of liquid beverage material by a conduit or supply line. In the embodiment shown in FIG. 12, there are two external supply reservoirs 123 and 124, each of which is configured to store either the same liquid beverage product or different products. These reservoirs 123, 124 are connected to the toroidal or annular vessel 117 by corresponding supply lines, conduits, or arrangements 121 and 122. The external supply reservoirs 123, 124 could be in the form of simple storage tanks, or in the form of liquid beverage product mixers, in at least one possible embodiment.

As well as the more typical filling machines having one toroidal vessel, it is possible that in at least one possible embodiment there could be a second toroidal or annular vessel which contains a second product. In this case, each filling arrangement 114 could be connected by separate connections to each of the two toroidal vessels and have two individually-controllable fluid or control valves, so that in each bottle 130, the first product or the second product can be filled by means of an appropriate control of the filling product or fluid valves.

Downstream of the beverage filling machine 105, in the direction of travel of the bottles 130, there can be a beverage bottle closing arrangement or closing station 106 which closes or caps the bottles 130. The beverage bottle closing arrangement or closing station 106 can be connected by a third conveyer arrangement 107 to a beverage bottle labeling arrangement or labeling station 108. The third conveyor arrangement may be formed, for example, by a plurality of starwheels, or may also include a linear conveyor device.

In the illustrated embodiment, the beverage bottle labeling arrangement or labeling station 108 has at least one labeling unit, device, or module, for applying labels to bottles 130. In the embodiment shown, the labeling arrangement 108 is connected by a starwheel conveyer structure to three output conveyer arrangements: a first output conveyer arrangement 109, a second output conveyer arrangement 110, and a third output conveyer arrangement 111, all of which convey filled, closed, and labeled bottles 130 to different locations.

The first output conveyer arrangement 109, in the embodiment shown, is designed to convey bottles 130 that are filled with a first type of liquid beverage supplied by, for example, the supply reservoir 123. The second output conveyer arrangement 110, in the embodiment shown, is designed to convey bottles 130 that are filled with a second type of liquid beverage supplied by, for example, the supply reservoir 124. The third output conveyer arrangement 111, in the embodiment shown, is designed to convey incorrectly labeled bottles 130. To further explain, the labeling arrangement 108 can comprise at least one beverage bottle inspection or monitoring device that inspects or monitors the location of labels on the bottles 130 to determine if the labels have been correctly placed or aligned on the bottles 130. The third output conveyer arrangement 111 removes any bottles 130 which have been incorrectly labeled as determined by the inspecting device.

The beverage bottling plant can be controlled by a central control arrangement 112, which could be, for example, computerized control system that monitors and controls the operation of the various stations and mechanisms of the beverage bottling plant.

With an apparatus 1 for the filling of bottles 2, in one possible embodiment with still water, with a product delivery by means of a filling valve 4 which is placed on the head of the bottle and a degassing line 12 for the removal from the interior of the bottle of the air displaced by the filling process, whereby the valve body 7 is realized so that it can be raised and lowered by means of a lifting wheel 8 which is guided over a slide path surface 9, an object of the present application is to essentially guarantee or promote a filling process which is as sterile as possible, i.e. to minimize the entry of germs via the filling head of the bottles.

The present application teaches that the valve body 7 which is provided with a passage hole 11 for the displaced air is provided on its free end with a guide cylinder 15 which represents an extension of the passage hole and is immovable connected to it, which guide cylinder is surrounded at some distance by a movable ring body 18, whereby a fluid-tight elastic collar is provided between the free end of the valve body and the edge of the movable ring body which faces this end.

One feature or aspect of an embodiment is believed at the time of the filing of this patent application to possibly reside broadly in an apparatus 1 for the filling of bottles 2, in one possible embodiment with still water, with a product delivery via a filling valve 4 which is placed over the head of the bottle and a degassing line 12 for the removal of the air displaced from the interior of the bottle during the filling process, whereby the valve body 7 is realized so that it can be raised and lowered by means of a lifting wheel 8 which is guided over a slide path surface 9, wherein the valve body 7 which is provided with a passage hole 11 for the displaced air is provided on its free end with a guide cylinder 15 which extends the passage hole and is connected immovably with it, which guide cylinder 15 is surrounded at some distance by a movable ring body 18, whereby a fluid tight elastic collar is provided between the free end of the valve body and the edge of the movable ring body facing this end.

Another feature or aspect of an embodiment is believed at the time of the filing of this patent application to possibly reside broadly in the apparatus, wherein the free end of the valve body 7 has a central blind hole 14 which has a larger diameter than the guide cylinder 15 which is fastened there and is provided in its bottom area with the product delivery line 6, 16.

Yet another feature or aspect of an embodiment is believed at the time of the filing of this patent application to possibly reside broadly in the apparatus, wherein the product delivery line which ends in the bottom area of the blind hole 14 is formed by the axle 16 of the lifting wheel 8.

Still another feature or aspect of an embodiment is believed at the time of the filing of this patent application to possibly reside broadly in the apparatus, wherein the guide cylinder 15 is provided with a conical bead 21 which projects outward for contact against at least one sealing ring 23 in the interior of the ring body 18.

A further feature or aspect of an embodiment is believed at the time of the filing of this patent application to possibly reside broadly in the apparatus, wherein the ring body 18 is provided in the interior with an additional sealing ring 24 by which it rests on the edge 23 of the bottle neck.

Another feature or aspect of an embodiment is believed at the time of the filing of this patent application to possibly reside broadly in the apparatus, wherein the ring body 18 is formed by two rings 19, 20 which are immovably connected to each other, whereby in the operating position, the upper ring 19 in the direction of gravity supports a ring 20 which projects downward from it and the inside diameter of which is, in some areas, larger than the diameter of the bottle head and which has an inner sealing ring 24 for contact with the edge of the bottle neck as well as a conical groove 22 which surrounds at some distance the conical bead 21 of the guide cylinder 15.

Yet another feature or aspect of an embodiment is believed at the time of the filing of this patent application to possibly reside broadly in the apparatus, wherein the guide cylinder 15 has a tubular extension 15a which extends toward the bottle to be filled and projects beyond the free end of the movable ring body.

Still another feature or aspect of an embodiment is believed at the time of the filing of this patent application to possibly reside broadly in the apparatus, wherein the ring body 18 equipped with the contact sealing ring 24 and the conical bead sealing ring 23 is held by the collar 17.

A further feature or aspect of an embodiment is believed at the time of the filing of this patent application to possibly reside broadly in a rotary beverage bottle filling machine for filling bottles with still water, said rotary beverage bottle filling machine comprising: a rotor being configured and disposed to rotate about a central, vertical, rotational axis; a cam structure being disposed to surround a portion of said rotor; a beverage reservoir being configured and disposed to hold a supply of still water; at least one beverage bottle filling element being configured and disposed to dispense a predetermined amount of still water into an empty beverage bottle; at least one supply line being configured and disposed to connect said at least one beverage bottle filling element to said beverage reservoir to permit the flow of still water from said beverage reservoir to said at least one beverage bottle filling element; said at least one beverage bottle filling element comprising: an elongated valve body having a longitudinal axis; a valve projection being connected to and disposed to project from said elongated valve body; a cam wheel being operatively connected to said elongated valve body and being configured to engage with said cam structure to move said elongated valve body and said valve projection connected thereto back and forth along the longitudinal axis of said elongated valve body; said elongated valve body and said valve projection together comprising a return gas channel being configured to permit the flow of air out from an empty beverage bottle upon filling of an empty beverage bottle; a movable ring body being disposed to surround at least a portion of said valve projection; said movable ring body and said valve projection being configured and disposed to together define an openable and closable liquid channel there between configured to permit the flow of non-carbonated liquid beverage out of said at least one beverage bottle filling element and into an empty beverage bottle to be filled; said movable ring body and said valve projection being configured to be moved relative to one another between a first position in which a portion of said movable ring body is in sealing engagement with a portion of said valve projection to close said liquid channel, and a second position in which the portion of said movable ring body is disengaged from the portion of said valve projection to open said liquid channel; said movable ring body being movably connected to said elongated valve body by an elastic collar; and said elastic collar being connected in a sealed manner to both of said movable ring body and said elongated valve body to minimize the entry of contaminants into the interior of said at least one filling element upon relative movement between said movable ring body and said elongated valve body to minimize contamination of still water to be dispensed into an empty beverage bottle.

Another feature or aspect of an embodiment is believed at the time of the filing of this patent application to possibly reside broadly in a beverage bottle filling machine for filling bottles with a non-carbonated beverage, such as still water, mineral water, spring water, juice, wine, sports drinks, and milk, said beverage bottle filling machine comprising: a beverage reservoir being configured and disposed to hold a supply of non-carbonated beverage; at least one beverage bottle filling element being configured and disposed to dispense a predetermined amount of non-carbonated beverage into an empty beverage bottle; at least one supply line being configured and disposed to connect said at least one beverage bottle filling element to said beverage reservoir to permit the flow of non-carbonated beverage from said beverage reservoir to said at least one beverage bottle filling element; said at least one beverage bottle filling element comprising: an elongated valve body having a longitudinal axis; a valve projection being connected to and disposed to project from said elongated valve body; a moving arrangement being operatively connected to said elongated valve body and being configured to move said elongated valve body and said valve projection connected thereto back and forth along the longitudinal axis of said elongated valve body; said elongated valve body and said valve projection together comprising a return gas channel being configured to permit the flow of gas from an empty beverage bottle upon filling of an empty beverage bottle; a movable ring body being disposed to surround at least a portion of said valve projection; said movable ring body and said valve projection being configured and disposed to together define an openable and closable liquid channel there between configured to permit the flow of non-carbonated liquid beverage out of said at least one beverage bottle filling element and into an empty beverage bottle to be filled; said movable ring body and said valve projection being configured to be moved relative to one another between a first position in which a portion of said movable ring body is in sealing engagement with a portion of said valve projection to close said liquid channel, and a second position in which the portion of said movable ring body is disengaged from the portion of said valve projection to open said liquid channel; and said movable ring body being movably connected to said elongated valve body by an elastic collar.

Yet another feature or aspect of an embodiment is believed at the time of the filing of this patent application to possibly reside broadly in a container filling machine for filling containers with a non-carbonated beverage, such as still water, mineral water, spring water, juice, wine, sports drinks, and milk, said container filling machine comprising: a beverage reservoir being configured and disposed to hold a supply of non-carbonated beverage; at least one container filling element being configured and disposed to dispense a predetermined amount of non-carbonated beverage into an empty container; at least one supply line being configured and disposed to connect said at least one container filling element to said beverage reservoir to permit the flow of non-carbonated beverage from said beverage reservoir to said at least one container filling element; said at least one container filling element comprising: an elongated valve body having a longitudinal axis; a valve projection being connected to and disposed to project from said elongated valve body; a moving arrangement being operatively connected to said elongated valve body and being configured to move said elongated valve body and said valve projection connected thereto back and forth along the longitudinal axis of said elongated valve body; said elongated valve body and said valve projection together comprising a return gas channel being configured to permit the flow of gas from an empty container upon filling of an empty container; a movable ring body being disposed to surround at least a portion of said valve projection; said movable ring body and said valve projection being configured and disposed to together define an openable and closable liquid channel there between configured to permit the flow of non-carbonated liquid beverage out of said at least one container filling element and into an empty container to be filled; said movable ring body and said valve projection being configured to be moved relative to one another between a first position in which a portion of said movable ring body is in sealing engagement with a portion of said valve projection to close said liquid channel, and a second position in which the portion of said movable ring body is disengaged from the portion of said valve projection to open said liquid channel; and said movable ring body being movably connected to said elongated valve body by an elastic collar.

The components disclosed in the various publications, disclosed or incorporated by reference herein, may possibly be used in possible embodiments of the present invention, as well as equivalents thereof.

The purpose of the statements about the technical field is generally to enable the Patent and Trademark Office and the public to determine quickly, from a cursory inspection, the nature of this patent application. The description of the technical field is believed, at the time of the filing of this patent application, to adequately describe the technical field of this patent application. However, the description of the technical field may not be completely applicable to the claims as originally filed in this patent application, as amended during prosecution of this patent application, and as ultimately allowed in any patent issuing from this patent application. Therefore, any statements made relating to the technical field are not intended to limit the claims in any manner and should not be interpreted as limiting the claims in any manner.

The appended drawings in their entirety, including all dimensions, proportions and/or shapes in at least one embodiment of the invention, are accurate and are hereby included by reference into this specification.

The background information is believed, at the time of the filing of this patent application, to adequately provide background information for this patent application. However, the background information may not be completely applicable to the claims as originally filed in this patent application, as amended during prosecution of this patent application, and as ultimately allowed in any patent issuing from this patent application. Therefore, any statements made relating to the background information are not intended to limit the claims in any manner and should not be interpreted as limiting the claims in any manner.

All, or substantially all, of the components and methods of the various embodiments may be used with at least one embodiment or all of the embodiments, if more than one embodiment is described herein.

The purpose of the statements about the object or objects is generally to enable the Patent and Trademark Office and the public to determine quickly, from a cursory inspection, the nature of this patent application. The description of the object or objects is believed, at the time of the filing of this patent application, to adequately describe the object or objects of this patent application. However, the description of the object or objects may not be completely applicable to the claims as originally filed in this patent application, as amended during prosecution of this patent application, and as ultimately allowed in any patent issuing from this patent application. Therefore, any statements made relating to the object or objects are not intended to limit the claims in any manner and should not be interpreted as limiting the claims in any manner.

All of the patents, patent applications and publications recited herein, and in the Declaration attached hereto, are hereby incorporated by reference as if set forth in their entirety herein.

The summary is believed, at the time of the filing of this patent application, to adequately summarize this patent application. However, portions or all of the information contained in the summary may not be completely applicable to the claims as originally filed in this patent application, as amended during prosecution of this patent application, and as ultimately allowed in any patent issuing from this patent application. Therefore, any statements made relating to the summary are not intended to limit the claims in any manner and should not be interpreted as limiting the claims in any manner.

It will be understood that the examples of patents, published patent applications, and other documents which are included in this application and which are referred to in paragraphs which state “Some examples of . . . which may possibly be used in at least one possible embodiment of the present application . . . ” may possibly not be used or useable in any one or more embodiments of the application.

The sentence immediately above relates to patents, published patent applications and other documents either incorporated by reference or not incorporated by reference.

The following patents, patent applications or patent publications, are hereby incorporated by reference as if set forth in their entirety herein: EP-516-604 A1, having the title “IMPROVEMENT TO A DEVICE FOR FILLING BOTTLES,” published on Dec. 2, 1992; and DE-10 2005 003 222-A1, having the following English translation of the German title “DEVICE FOR FILLING CONTAINERS HAS FILLER PIPE WITH STANDPIPE WITH VALVE BODY ON OUTSIDE AND GAS PIPE ON INSIDE WHICH ARE VERTICALLY MOVABLE INDEPENDENT OF ONE ANOTHER TO FORM RING CHAMBER OPENING DOWNWARDS,” published on Jul. 27, 2006.

All of the patents, patent applications or patent publications, which were cited in the International Search Report dated May 14, 2008, and/or cited elsewhere are hereby incorporated by reference as if set forth in their entirety herein as follows: DE 33 25 338, having the following English translation of the German title “Filling device for still drinks,” published on Jan. 31, 1985; and DE 87 14 020, having the German title “FÜLLELEMENT ZUM ABFÜLLEN VON FLÜSSIGKEITEN,” published on Nov. 17, 1988.

The patents, patent applications, and patent publication listed above in the preceding two paragraphs are herein incorporated by reference as if set forth in their entirety. The purpose of incorporating U.S. patents, Foreign patents, publications, etc. is solely to provide additional information relating to technical features of one or more embodiments, which information may not be completely disclosed in the wording in the pages of this application. Words relating to the opinions and judgments of the author and not directly relating to the technical details of the description of the embodiments therein are not incorporated by reference. The words all, always, absolutely, consistently, preferably, guarantee, particularly, constantly, ensure, necessarily, immediately, endlessly, avoid, exactly, continually, expediently, need, must, only, perpetual, precise, perfect, require, requisite, simultaneous, total, unavoidable, and unnecessary, or words substantially equivalent to the above-mentioned words in this sentence, when not used to describe technical features of one or more embodiments, are not considered to be incorporated by reference herein.

The corresponding foreign and international patent publication applications, namely, Federal Republic of Germany Patent Application No. 10 2006 050 780.0, filed on Oct. 27, 2006, having inventors Dieter-Rudolf KRULITSCH and Bernd BRUCH, and DE-OS 10 2006 050 780.0 and DE-PS 10 2006 050 780.0, and International Application No. PCT/EP2007/009214, filed on Oct. 24, 2007, having WIPO Publication No. WO2008/049591 and inventors Dieter-Rudolf KRULITSCH and Bernd BRUCH, are hereby incorporated by reference as if set forth in their entirety herein for the purpose of correcting and explaining any possible misinterpretations of the English translation thereof. In addition, the published equivalents of the above corresponding foreign and international patent publication applications, and other equivalents or corresponding applications, if any, in corresponding cases in the Federal Republic of Germany and elsewhere, and the references and documents cited in any of the documents cited herein, such as the patents, patent applications and publications, are hereby incorporated by reference as if set forth in their entirety herein.

The purpose of incorporating the Foreign equivalent patent application PCT/EP2007/009214 and German Patent Application 10 2006 050 780.0 is solely for the purpose of providing a basis of correction of any wording in the pages of the present application, which may have been mistranslated or misinterpreted by the translator. Words relating to opinions and judgments of the author and not directly relating to the technical details of the description of the embodiments therein are not to be incorporated by reference. The words all, always, absolutely, consistently, preferably, guarantee, particularly, constantly, ensure, necessarily, immediately, endlessly, avoid, exactly, continually, expediently, need, must, only, perpetual, precise, perfect, require, requisite, simultaneous, total, unavoidable, and unnecessary, or words substantially equivalent to the above-mentioned word in this sentence, when not used to describe technical features of one or more embodiments, are not generally considered to be incorporated by reference herein.

Statements made in the original foreign patent applications PCT/EP2007/009214 and DE 10 2006 050 780.0 from which this patent application claims priority which do not have to do with the correction of the translation in this patent application are not to be included in this patent application in the incorporation by reference.

All of the references and documents, cited in any of the documents cited herein, are hereby incorporated by reference as if set forth in their entirety herein. All of the documents cited herein, referred to in the immediately preceding sentence, include all of the patents, patent applications and publications cited anywhere in the present application.

The description of the embodiment or embodiments is believed, at the time of the filing of this patent application, to adequately describe the embodiment or embodiments of this patent application. However, portions of the description of the embodiment or embodiments may not be completely applicable to the claims as originally filed in this patent application, as amended during prosecution of this patent application, and as ultimately allowed in any patent issuing from this patent application. Therefore, any statements made relating to the embodiment or embodiments are not intended to limit the claims in any manner and should not be interpreted as limiting the claims in any manner.

The details in the patents, patent applications and publications may be considered to be incorporable, at applicant's option, into the claims during prosecution as further limitations in the claims to patentably distinguish any amended claims from any applied prior art.

The purpose of the title of this patent application is generally to enable the Patent and Trademark Office and the public to determine quickly, from a cursory inspection, the nature of this patent application. The title is believed, at the time of the filing of this patent application, to adequately reflect the general nature of this patent application. However, the title may not be completely applicable to the technical field, the object or objects, the summary, the description of the embodiment or embodiments, and the claims as originally filed in this patent application, as amended during prosecution of this patent application, and as ultimately allowed in any patent issuing from this patent application. Therefore, the title is not intended to limit the claims in any manner and should not be interpreted as limiting the claims in any manner.

The abstract of the disclosure is submitted herewith as required by 37 C.F.R. §1.72(b). As stated in 37 C.F.R. §1.72(b):
A brief abstract of the technical disclosure in the specification must commence on a separate sheet, preferably following the claims, under the heading “Abstract of the Disclosure.” The purpose of the abstract is to enable the Patent and Trademark Office and the public generally to determine quickly from a cursory inspection the nature and gist of the technical disclosure. The abstract shall not be used for interpreting the scope of the claims.
   Therefore, any statements made relating to the abstract are not intended to limit the claims in any manner and should not be interpreted as limiting the claims in any manner.

The embodiments of the invention described herein above in the context of the preferred embodiments are not to be taken as limiting the embodiments of the invention to all of the provided details thereof, since modifications and variations thereof may be made without departing from the spirit and scope of the embodiments of the invention.

### AT LEAST PARTIAL NOMENCLATURE

1 Apparatus
2 Bottle
2a Bottle neck
2b Bottle interior
3 Holder
4 Filling valve
5 Product tank
6 Product delivery line
7 Valve body
8 Lifting wheel
9 Slide path surface
10 Double arrow
10a Arrow
10b Arrow
11 Passage hole
12 Degassing line
13 Stop collar
14 Central blind hole
15 Guide cylinder
15a Tubular extension
16 Product delivery line (axle)
17 Collar
18 Ring body
19 Ring
20 Ring
21 Conical bead
22 Conical groove
23 Sealing ring
24 Sealing ring

What is claimed is:

1. A rotary beverage bottle filling machine for filling bottles with still water, said rotary beverage bottle filling machine comprising:
a rotor being configured and disposed to rotate about a central, vertical, rotational axis;
a cam structure being disposed to surround a portion of said rotor;
a beverage reservoir being configured and disposed to hold a supply of still water;
at least one beverage bottle filling element being configured and disposed to dispense a predetermined amount of still water into an empty beverage bottle;
at least one supply line being configured and disposed to connect said at least one beverage bottle filling element to said beverage reservoir to permit the flow of still water from said beverage reservoir to said at least one beverage bottle filling element;
said at least one beverage bottle filling element comprising:
an elongated valve body having a longitudinal axis;
a valve projection being connected to and disposed to project from said elongated valve body;
a cam wheel being operatively connected to said elongated valve body and being configured to engage with said cam structure to move said elongated valve body and said valve projection connected thereto back and forth along the longitudinal axis of said elongated valve body;
said elongated valve body and said valve projection together comprising a return gas channel being configured to permit the flow of air out from an empty beverage bottle upon filling of an empty beverage bottle;
a movable ring body being disposed to surround at least a portion of said valve projection;
said movable ring body and said valve projection being configured and disposed to together define an openable and closable liquid channel there between configured to permit the flow of non-carbonated liquid beverage out of said at least one beverage bottle filling element and into an empty beverage bottle to be filled;
said movable ring body and said valve projection being configured to be moved relative to one another between a first position in which a portion of said movable ring body is in sealing engagement with a portion of said valve projection to close said liquid channel, and a second position in which the portion of said movable ring body is disengaged from the portion of said valve projection to open said liquid channel;
said movable ring body being movably connected to said elongated valve body by an elastic collar; and
said elastic collar being connected in a sealed manner to both of said movable ring body and said elongated valve body to minimize the entry of contaminants into the interior of said at least one filling element upon relative movement between said movable ring body and said elongated valve body to minimize contamination of still water to be dispensed into an empty beverage bottle.

2. The filling machine according to claim 1, wherein the end of said elongated valve body has a central blind hole therein which has a larger diameter than said valve projection and surrounds at least a portion of said valve projection which is connected there, wherein said elongated valve body and said valve projection are configured and disposed to together define a portion of said openable and closable liquid channel.

3. The filling machine according to claim 2, wherein the axle said cam wheel comprises an opening therein configured and disposed to connect said at least one supply line to the portion of said liquid channel in said blind hole of said elongated valve body.

4. The filling machine according to claim 3, wherein said valve projection comprises a conical protrusion disposed to protrude radially outwardly, and configured to placed in contact against at least one sealing ring in the interior of said ring body to close said liquid channel.

5. The filling machine according to claim 4, wherein:
said ring body comprises an additional sealing ring disposed in the interior thereof and configured to rests on the edge of a beverage bottle neck upon filling of an empty beverage bottle; and
said ring body is formed by two rings which are immovably connected to each other, whereby in the operating position, the upper ring in the direction of gravity supports a ring which projects downward from it and the inside diameter of which is, in some areas, larger than the diameter of a beverage bottle head and which has an inner sealing ring for contact with the edge of a beverage bottle neck as well as a conical groove which surrounds at some distance the conical protrusion of said valve projection.

6. The filling machine according to claim 5, wherein:
said valve projection has a tubular extension configured to extend toward and at least partially into a beverage bottle to be filled and projects beyond said movable ring body; and
said ring body equipped with said contact sealing ring and said conical protrusion sealing ring is held by said elastic collar.

7. A beverage bottle filling machine for filling bottles with a non-carbonated beverage, such as still water, mineral water, spring water, juice, wine, sports drinks, and milk, said beverage bottle filling machine comprising:
a beverage reservoir being configured and disposed to hold a supply of non-carbonated beverage;
at least one beverage bottle filling element being configured and disposed to dispense a predetermined amount of non-carbonated beverage into an empty beverage bottle;
at least one supply line being configured and disposed to connect said at least one beverage bottle filling element to said beverage reservoir to permit the flow of non-carbonated beverage from said beverage reservoir to said at least one beverage bottle filling element;
said at least one beverage bottle filling element comprising:
an elongated valve body having a longitudinal axis;
a valve projection being connected to and disposed to project from said elongated valve body;
a moving arrangement being operatively connected to said elongated valve body and being configured to move said elongated valve body and said valve projection connected thereto back and forth along the longitudinal axis of said elongated valve body;
said elongated valve body and said valve projection together comprising a return gas channel being configured to permit the flow of gas from an empty beverage bottle upon filling of an empty beverage bottle;
a movable ring body being disposed to surround at least a portion of said valve projection;
said movable ring body and said valve projection being configured and disposed to together define an openable and closable liquid channel there between configured to permit the flow of non-carbonated liquid beverage out of said at least one beverage bottle filling element and into an empty beverage bottle to be filled;
said movable ring body and said valve projection being configured to be moved relative to one another between a first position in which a portion of said movable ring body is in sealing engagement with a portion of said valve projection to close said liquid channel, and a second position in which the portion of said movable ring body is disengaged from the portion of said valve projection to open said liquid channel; and
said movable ring body being movably connected to said elongated valve body by an elastic collar.

8. The filling machine according to claim 7, wherein the end of said elongated valve body has a central blind hole therein which has a larger diameter than said valve projection and surrounds at least a portion of said valve projection which is connected there, wherein said elongated valve body and said valve projection are configured and disposed to together define a portion of said openable and closable liquid channel.

9. The filling machine according to claim 8, wherein said moving arrangement comprises a cam wheel configured to engage with a cam structure, and the axle of said cam wheel comprises an opening therein configured and disposed to connect said at least one supply line to the portion of said liquid channel in said blind hole of said elongated valve body.

10. The filling machine according to claim 9, wherein said valve projection comprises a conical protrusion disposed to protrude radially outwardly, and configured to placed in contact against at least one sealing ring in the interior of said ring body to close said liquid channel.

11. The filling machine according to claim 10, wherein said ring body comprises an additional sealing ring disposed in the interior thereof and configured to rests on the edge of a beverage bottle neck upon filling of an empty beverage bottle.

12. The filling machine according to claim 11, wherein said ring body is formed by two rings which are immovably connected to each other, whereby in the operating position, the upper ring in the direction of gravity supports a ring which projects downward from it and the inside diameter of which is, in some areas, larger than the diameter of a beverage bottle head and which has an inner sealing ring for contact with the edge of a beverage bottle neck as well as a conical groove which surrounds at some distance the conical protrusion of said valve projection.

13. The filling machine according to claim 12, wherein:
said valve projection has a tubular extension configured to extend toward and at least partially into a beverage bottle to be filled and projects beyond said movable ring body; and
said ring body equipped with said contact sealing ring and said conical protrusion sealing ring is held by said elastic collar.

14. A container filling machine for filling containers with a non-carbonated beverage, such as still water, mineral water, spring water, juice, wine, sports drinks, and milk, said container filling machine comprising:
a beverage reservoir being configured and disposed to hold a supply of non-carbonated beverage;
at least one container filling element being configured and disposed to dispense a predetermined amount of non-carbonated beverage into an empty container;
at least one supply line being configured and disposed to connect said at least one container filling element to said beverage reservoir to permit the flow of non-carbonated beverage from said beverage reservoir to said at least one container filling element;
said at least one container filling element comprising:
an elongated valve body having a longitudinal axis;
a valve projection being connected to and disposed to project from said elongated valve body;
a moving arrangement being operatively connected to said elongated valve body and being configured to move said elongated valve body and said valve projection connected thereto back and forth along the longitudinal axis of said elongated valve body;
said elongated valve body and said valve projection together comprising a return gas channel being configured to permit the flow of gas from an empty container upon filling of an empty container;
a movable ring body being disposed to surround at least a portion of said valve projection;
said movable ring body and said valve projection being configured and disposed to together define an openable and closable liquid channel there between configured to permit the flow of non-carbonated liquid beverage out of said at least one container filling element and into an empty container to be filled;
said movable ring body and said valve projection being configured to be moved relative to one another between a first position in which a portion of said movable ring body is in sealing engagement with a portion of said valve projection to close said liquid channel, and a second position in which the portion of said movable ring body is disengaged from the portion of said valve projection to open said liquid channel; and
said movable ring body being movably connected to said elongated valve body by an elastic collar.

15. The filling machine according to claim 14, wherein the end of said elongated valve body has a central blind hole therein which has a larger diameter than said valve projection and surrounds at least a portion of said valve projection which is connected there, wherein said elongated valve body and said valve projection are configured and disposed to together define a portion of said openable and closable liquid channel.

16. The filling machine according to claim 15, wherein said moving arrangement comprises a cam wheel configured to engage with a cam structure, and the axle of said cam wheel comprises an opening therein configured and disposed to connect said at least one supply line to the portion of said liquid channel in said blind hole of said elongated valve body.

17. The filling machine according to claim 16, wherein said valve projection comprises a conical protrusion disposed to protrude radially outwardly, and configured to placed in contact against at least one sealing ring in the interior of said ring body to close said liquid channel.

18. The filling machine according to claim 17, wherein said ring body comprises an additional sealing ring disposed in the interior thereof and configured to rests on the edge of a container neck upon filling of an empty container.

19. The filling machine according to claim 18, wherein said ring body is formed by two rings which are immovably connected to each other, whereby in the operating position, the upper ring in the direction of gravity supports a ring which projects downward from it and the inside diameter of which is, in some areas, larger than the diameter of a container head and which has an inner sealing ring for contact with the edge of a container neck as well as a conical groove which surrounds at some distance the conical protrusion of said valve projection.

20. The filling machine according to claim 19, wherein:
said valve projection has a tubular extension configured to extend toward and at least partially into a container to be filled and projects beyond said movable ring body; and
said ring body equipped with said contact sealing ring and said conical protrusion sealing ring is held by said elastic collar.
